(19) United States
(12) Patent Application Publication
(10) Pub. No.: US 2025/0303208 A1
(43) Pub. Date: Oct. 2, 2025

(54) FOAM-WATER FIRE SPRINKLER

(71) Applicant: The Reliable Automatic Sprinkler Co. Inc., Liberty, SC (US)

(72) Inventors: Steven Wolin, Clemson, SC (US); Brian Bassett, Lyman, SC (US); John Desrosier, Plymouth, MA (US)

(21) Appl. No.: 18/621,581

(22) Filed: Mar. 29, 2024

(51) Int. Cl. A62C 31/12; A62C 5/02

(52) U.S. Cl. CPC A62C 31/12; A62C 5/024

(57) ABSTRACT

A foam-water fire sprinkler includes a nozzle, a shroud body, an agitator, and a deflector. The nozzle defines a nozzle passage that receives a foam-water solution therein. The shroud body defines a shroud passage that receives the foam-water solution from the nozzle passage. The agitator is positioned within the shroud passage, and has a rounded agitator portion and a straight agitator portion that extends from the rounded agitator portion. The foam-water solution impinges on the agitator at the rounded agitator portion to aspirate the foam-water solution with air to generate foam. A portion of the foam-water solution separates from the agitator at the straight agitator portion. The deflector deflects the foam-water solution and the foam to generate a spray pattern of the foam-water solution and the foam at a coverage area.

### TECHNICAL FIELD

The present disclosure relates generally to fire sprinklers, particularly, to a foam-water fire sprinkler.

### BACKGROUND

Historically, there have been many different types of chemical additives mixed with water to alter the properties of the water to help with the efficiency of fighting specific types of fires. Typical fire protection engineering protocol requires a hazard analysis to determine potential ignition sources as well as potential fire sizes in the event that an ignition source does start a fire. Flammable liquid hazards, such as fuel, historically have been very difficult to protect because flammable liquids have a very high potential energy. When the fuel is burned, a tremendous amount of heat is generated for the volume of fuel burned. This rapid release of energy adds to the vaporization of more fuel, which, in turn, mixes with oxygen in the atmosphere and combusts. This, in turn, releases more energy and the fire continues to grow exponentially until the fuel is limited by oxygen, or the fuel is consumed at the same rate at which a pool is growing. In that case, the fire will continue to burn at a constant rate until all the fuel is consumed.

The use of only water as a suppressant has had limited success in controlling flammable liquid fires. The incredible amount of heat released by a small volume of fuel makes it difficult to remove enough energy from the system to stop the fire growth cycle. Vast amounts of water are needed to control this type of hazard. The water is used to cool the area around the fire location to limit the amount of energy that is reintroduced to the fuel. This is completed by removing energy from the cycle by creating steam. The transition of water to steam removes energy from the system and the introduction of the steam helps to displace oxygen from the fuel. This energy removal, and oxygen displacement, are the primary means of which water interrupts the flammable liquid burning cycle. But flammable liquid fires have so much potential energy that the amount of water needed to control or to suppress the fire is generally not available, or is cost prohibitive. In some circumstances, the flammable liquid temperature rises to a temperature above the boiling point of water. The application of water to the hot flammable liquid can cause frothing or can cause a violent eruption. The water penetrates the top surface of the hot flammable liquid. The water then vaporizes into steam. The rapid expansion of the water to steam (approximately one thousand times the volume) can create a violent eruption of flammable liquid. This eruption can cause the fire to spread, increase the heat release rate, and create a potentially very hazardous situation. Further, many flammable liquids are less dense than water, and the application of water will spread the combusting flammable liquids throughout the space.

The introduction of a water additive helps alter the properties of the water, which allows for a different control/suppression mechanism. One such water additive is foam. The general mechanism used to control or to suppress the fire with the use of foam is the displacement of the fuel oxygen interface. By creating a film or a blanket on the top surface of the fuel, the foam separates the needed oxygen from the fuel, disrupting the flammable liquid burning cycle.

In general, foam systems are comprised of a water supply, a system valve, a proportioner, a hydraulic concentrate control valve (a way to initiate the flow of concentrate to the proportioner), a bladder tank or a foam pump, and multiple discharge devices, along with associated piping to connect each of the components listed above. The water supply can be fed by the city (with or without the use of a booster pump), a pump and a tank, or any other approved supply by the local authority having jurisdiction. The supply piping is generally fed underground into the building. The underground piping penetrates the ground into a riser room having one or more system valves. A valve controls the foam-water system, and is connected to the piping that rises from the underground. This valve may be an alarm valve (wet system), a deluge valve (deluge system), or any other water control valve.

Although there are countless other means to configure a foam system, the most common application is to use an intermediate chamber on the system control valve to initiate the flow of foam concentrate. Under normal conditions (no water flowing) the intermediate chamber of the valve is empty and open to atmospheric pressure. Upon the start of water flow through the valve, the valve clapper will rise off the seat. The clapper movement allows for a small portion of the water flowing through the valve to be diverted through the intermediate chamber. Piping is connected to the discharge of the intermediate chamber of the valve that leads to a hydraulic concentrate control valve. The hydraulic concentrate control valve opens upon pressure acting on the hydraulic concentrate control valve, which allows for the flow of concentrate from the bladder tank/foam pump to the concentrate inlet of the proportioner.

The most common type of proportioning system is a balanced pressure proportioning system that uses a modified venturi to accurately introduce a specific amount of foam concentrate into the water flowing through the proportioner that is proportional to the flow rate of the water through the proportioner. The foam concentrate mixes with the water upon the discharge of the proportioner, thereby producing a foam-water solution. The foam-water solution is then discharged through the system piping to a number of discharge devices.

Each combination of foam discharge device and water solution (water with concentrate added) is tested in conjunction with each other to prove the efficacy of the combination. One important factor that can affect the efficacy of the discharge device foam solution combination is the expansion ratio. The expansion ratio is a measure of how much the volume of the foam-water solution is increased from the inlet of the discharge device to the outlet or application of the foam to the hazard. Different combinations of concentrates and discharge devices can have much different expansion ratios, and, thus, are more efficient or less efficient at controlling/suppressing the fire.

Discharge devices can have many different shapes and sizes. In general, discharge devices include a restricted orifice and a mechanical device to agitate the foam-water solution.

Automatic sprinklers have historically been used as discharge devices for foam. Generally, however, automatic sprinklers are not specifically designed to optimally discharge a foam-water solution. In particular, the use of automatic sprinklers was used to design a wet foam-water fire sprinkler system to take advantage of the fact that only the sprinklers located around the potential fire will activate, limiting the required infrastructure. By using automatic closed devices, the number of foam risers can be decreased, the size of the piping, the potential damage for a false activation is significantly reduced, and the total amount of foam concentrate needed for any application is reduced.

The two main types of foam sprinkler systems are deluge systems or wet systems (dry and pre-action are also allowed but not common). With a deluge type sprinkler system, all the discharge devices are open. A foam solution will discharge from all devices upon operation of the system control valve. The water is withheld at the system valve by a system control valve, also referred to as a deluge valve. Upon detection of a fire, the deluge valve is released and allows the water to flow through the proportioner where the water becomes a foam solution and ultimately to flow towards the discharge devices. The discharge devices could be anything from high expansion foam generators, to foam makers, to open type sprinklers. Having a fixed number of discharging devices allows for the use of a typical proportioning device that has a fixed flow range. Having the exact number of discharge devices helps to ensure the correct proportioning device is chosen. These types of foam systems typically protect a limited area hazard, such as, for example, a tank holding flammable liquids, or an airplane hangar protecting airplanes within. In deluge systems, the hazard must be within the area in which the open nozzles are located. The infrastructure of the piping must be sized to accommodate all the discharge devices at one time.

Sprinkler systems (water only) are typically installed when required by the building code. Generally, the entirety of the building must be protected throughout with automatic sprinklers (with a few small exceptions). The most common sprinkler system is a wet system, which uses automatic sprinklers with water filled piping up to the inlet of the sprinklers. Automatic sprinklers include a thermal element that supports a plug at an outlet of the automatic sprinkler. Upon the thermal element of the sprinkler being exposed to excessive heat, the thermal element will be broken/ejected and allow the flow of water out of the sprinkler. Although the entire building is protected by sprinklers, the infrastructure feeding the sprinkler system does not need to accommodate every sprinkler in the building operating at once. A subset of sprinklers is chosen based on the hydraulically most demanding area. Typically, there is an expected area of operation if a fire were to start. The expected area of operation starts in the hydraulically most remote area, most commonly, the area the furthest distance from the system riser. Once the area is determined, a particular number of sprinklers is located within that area. Typically, this is a small fraction of sprinklers of the entire building. By only assuming a fraction of sprinklers operating, water sprinkler systems allow for a cost-effective piping design, pump, and installation. This also helps with the uncertainty of fire ignition location. The proportioners for these types of systems are typically specialized to accommodate flow from a single sprinkler up to a maximum flow rate.

Automatic fire sprinklers have been used in foam-water fire sprinkler systems. The foam-water solution flows through the sprinkler inlet and is forced upon the sprinkler deflector. Generally, automatic fire sprinklers are not specifically designed to create foam. Due to their inherent nature of aggressively discharging a water jet from the inlet of the sprinkler to the fixed deflector, this imparts mechanical energy/turbulence needed to create some foam. Many of the devices disclosed previously, such as foam makers or high expansion generators, are designed to promote mixing and mechanical agitation of the foam-water solution. One way to optimize the foam generation is to introduce air into the mechanical agitation. This introduction of air is generally called air aspiration.

There have even been specific foam-water fire sprinklers that use air aspiration to optimize foam production. By giving the sprinkler a skirt with openings directly near the inlet of the sprinkler paired with a member interrupting the water jet coming from the sprinkler inlet, allows for the mechanical energy from the velocity of the water jet to interact with the supporting member of the sprinkler. Creating a volume and an entrance for air to entrain into the assembly allows for mixing of air and foam-water solution. This intermediate step before interacting with the deflector helps immensely with the expansion ratio and the efficacy of the sprinkler. The agitated foam solution then interacts with the deflector, which not only helps with the expansion ratio but is used to send the agitated foam solution towards the protection area, also referred to as a coverage area. The intermediate mixing of the air and foam-water solution with the skirted area allows for an optimization of foam expansion. The better that the foam-water fire sprinkler optimizes the foam expansion, the better the foam-water fire sprinkler performs under fire conditions.

Currently, the introduction of per- and poly-fluoroalkyl substances (PFAS) are being phased out of the fire suppression industry. The fire suppression industry is replacing PFAS with other suitable, but less efficient, foam concentrates. Within aqueous film forming foam (AFFF), PFAS are being replaced with synthetic fluorine free foam (SFFF), which is generally less efficient than PFAS. The optimization of the discharge device is critical to maintain the industry-expected fire test result while using less efficient foam concentrates.

Creating an optimized automatic foam-water fire sprinkler is a new concept. Typically, if a foam-water fire sprinkler system was wanted or was required, the lack of efficiency of the discharge device was accepted to take advantage of the automatic portion of the typical automatic fire sprinkler. Accordingly, the present disclosure provides for adding a thermal element to an air aspirating foam-water fire sprinkler, thereby allowing for a more economical protection of a wide area with the potential for flammable liquid fires. The more efficient the discharge device is, the lower the concentration of the foam-water solution can be (i.e., 1% vs 3% or 6%), resulting in less foam concentrate. Or, adversely, the more efficient the foam discharge device is, the less efficient the foam-water solution has to be, and, thus, generally a cheaper, less efficient, concentrate can be utilized. Either situation results in a lower installed cost of the foam-water fire sprinkler system.

### SUMMARY

In one embodiment, the present disclosure provides a foam-water fire sprinkler that includes a nozzle defining a nozzle passage having a nozzle inlet and a nozzle outlet, the nozzle passage receiving a foam-water solution therein through the nozzle inlet, a shroud body defining a shroud passage having a shroud inlet and a shroud outlet, the shroud passage receiving the foam-water solution from the nozzle passage through the shroud inlet, an agitator positioned within the shroud passage, the agitator having a rounded agitator portion and a straight agitator portion that extends from the rounded agitator portion, and the foam-water solution impinging on the agitator at the rounded agitator portion to aspirate the foam-water solution with air to generate foam, and a portion of the foam-water solution separating from the agitator at the straight agitator portion, and a deflector that deflects the foam-water solution and the foam to generate a spray pattern of the foam-water solution and the foam at a coverage area.

In another embodiment, the present disclosure provides a foam-water fire sprinkler that includes a nozzle defining a nozzle passage having a nozzle inlet and a nozzle outlet, the nozzle passage receiving a foam-water solution therein through the nozzle inlet, and a shroud body defining a shroud passage having a shroud inlet and a shroud outlet, the shroud passage receiving the foam-water solution from the nozzle passage through the shroud inlet. The shroud body includes a converging tapered shroud portion that tapers inward from the shroud inlet such that a shroud passage diameter of the shroud passage decreases from the shroud inlet along the converging tapered shroud portion, a straight shroud portion that extends substantially axially from the converging tapered shroud portion to the shroud outlet, wherein the shroud passage diameter remains generally constant along the straight shroud portion to the shroud outlet, and a transition shroud portion that defines a radial step between the converging tapered shroud portion and the straight shroud portion, wherein the shroud passage diameter increases at the transition shroud portion between the converging tapered shroud portion and the straight shroud portion. The sprinkler also includes an agitator positioned within the shroud passage. The agitator includes a rounded agitator portion, a straight agitator portion that extends from the rounded agitator portion, wherein the agitator is positioned within the shroud passage such that the straight agitator portion is axially aligned with a smallest shroud passage diameter of the shroud passage defined by the converging tapered shroud portion, a tip defined by the rounded agitator portion, wherein the agitator is positioned within the shroud passage at an agitator axial distance defined from the nozzle outlet to the tip of the agitator, and the agitator axial distance is in a range of zero point six two five inches to one point two inches (fifteen millimeters to thirty millimeters), and an axial end that is generally planar and defines sharp edges of the agitator, wherein the foam-water solution impinges on the agitator at the rounded agitator portion to aspirate the foam-water solution with air to generate foam, and the sharp edges causing a portion of the foam-water solution to separate from the agitator. The sprinkler also includes a deflector that deflects the foam-water solution and the foam to generate a spray pattern of the foam-water solution and the foam at a coverage area, wherein the deflector is positioned at a deflector axial distance from the shroud outlet, the deflector axial distance being in a range of one point one inches to two inches (twenty-eight millimeters to fifty-one millimeters).

In another embodiment, the present disclosure provides a foam-water fire sprinkler that includes a nozzle defining a nozzle passage having a nozzle inlet and a nozzle outlet, the nozzle passage receiving a foam-water solution therein through the nozzle inlet, and a shroud body defining a shroud passage having a shroud inlet and a shroud outlet, the shroud passage receiving the foam-water solution from the nozzle passage through the shroud inlet. The sprinkler also includes an agitator positioned within the shroud passage, the foam-water solution impinging on the agitator to aspirate the foam-water solution with air to generate foam. The sprinkler also includes a deflector that deflects the foam-water solution and the foam to generate a spray pattern of the foam-water solution and the foam at a coverage area. The sprinkler also includes a release mechanism including a seal cap disposed within the nozzle outlet to seal the nozzle outlet, and a thermally-responsive element positioned between the agitator and the seal cap to hold the seal cap in place within the nozzle outlet, the thermally-responsive element releasing the seal cap at a predetermined temperature such that the seal cap is released from the nozzle outlet to allow the foam-water solution to flow through the nozzle passage and into the shroud passage towards the deflector.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, and/or structurally similar elements.

FIG. 1A is a schematic view of a foam-water fire sprinkler, according to the present disclosure.

FIG. 1B is a side view of the foam-water fire sprinkler of FIG. 1A, according to the present disclosure.

FIG. 1C is a bottom plan view of the foam-water fire sprinkler of FIG. 1A, according to the present disclosure.

FIG. 1D is a longitudinal cross-sectional view of the foam-water fire sprinkler, taken along section line 1D-1D in FIG. 1C, according to the present disclosure.

FIG. 2A is a schematic view of a foam-water fire sprinkler, according to another embodiment.

FIG. 2B is a side view of the foam-water fire sprinkler of FIG. 2A, according to the present disclosure.

FIG. 2C is a bottom plan view of the foam-water fire sprinkler of FIG. 2A, according to the present disclosure.

FIG. 2D is a longitudinal cross-sectional view of the foam-water fire sprinkler, taken along section line 2D-2D in FIG. 2C, according to the present disclosure.

FIG. 2E is a lateral cross-sectional view of the foam-water fire sprinkler, taken along section line 2E-2E in FIG. 2D, according to the present disclosure.

FIG. 3A is a schematic view of a foam-water fire sprinkler, according to another embodiment.

FIG. 3B is a side view of the foam-water fire sprinkler of FIG. 3A, according to the present disclosure.

FIG. 3C is a bottom plan view of the foam-water fire sprinkler of FIG. 3A, according to the present disclosure.

FIG. 3D is a longitudinal cross-sectional view of the foam-water fire sprinkler, taken along section line 3D-3D in FIG. 3C, according to the present disclosure.

FIG. 4A is a schematic view of a foam-water fire sprinkler, according to another embodiment.

FIG. 4B is a side view of the foam-water fire sprinkler of FIG. 4A, according to the present disclosure.

FIG. 4C is a bottom plan view of the foam-water fire sprinkler of FIG. 4A, according to the present disclosure.

FIG. 4D is a longitudinal cross-sectional view of the foam-water fire sprinkler, taken along section line 4D-4D in FIG. 4C, according to the present disclosure.

FIG. 4E is a lateral cross-sectional view of the foam-water fire sprinkler, taken along section line 4E-4E in FIG. 4D, according to the present disclosure.

### DETAILED DESCRIPTION

Additional features, advantages, and embodiments of the present disclosure are set forth or apparent from a consideration of the following detailed description, drawings, and claims. Moreover, both the foregoing summary of the present disclosure and the following detailed description are exemplary and intended to provide further explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the spirit and the scope of the present disclosure.

As used herein, the terms “first” and “second,” etc. may be used interchangeably to distinguish one component from another and are not intended to signify location or importance of the individual components.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially” is not to be limited to the precise value specified. In at least some instances, the approximating language may correspond to the precision of an instrument for measuring the value, or the precision of the methods or the machines for constructing the components and/or the systems or manufacturing the components and/or the systems. For example, the approximating language may refer to being within a one, two, four, ten, fifteen, or twenty percent margin in either individual values, range(s) of values and/or endpoints defining range(s) of values.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

An automatic foam dispersion device with internal air aspiration can be used to protect fires involving flammable liquids. Flammable liquid fires historically are challenging fires without the use of a foam additive. There are a multitude of discharge devices that are used to distribute the foam-water solution. Standard spray sprinklers have been used for discharge devices since the inception of foam. The foam-water solution is discharged through the inlet portion of the sprinkler and discharged towards the deflector. The mechanical disturbance of the foam-water solution interacting with the deflector of the sprinkler imparts enough mechanical energy to agitate the foam-water mixture to create a “blanket” of foam on the surface of the flammable liquids fire. This generally interrupts the chemical reaction and separates the oxygen from the fuel source, eventually controlling or extinguishing the fire. The efficacy of the discharge device to create more foam or to increase the expansion ratio has a drastic result on the time to extinguish the fire as well as the required foam-water concentration. Using an optimized discharge device allows for a less expensive or a less efficient foam-water solution. Adding an automatic heat detection device allows for a much more cost-effective system design to protect a flammable liquids hazard. By creating an air aspirated automatic foam-water nozzle, the efficacy of the created foam is significantly enhanced as well as the system design, optimally discharging foam in the area of fire ignition.

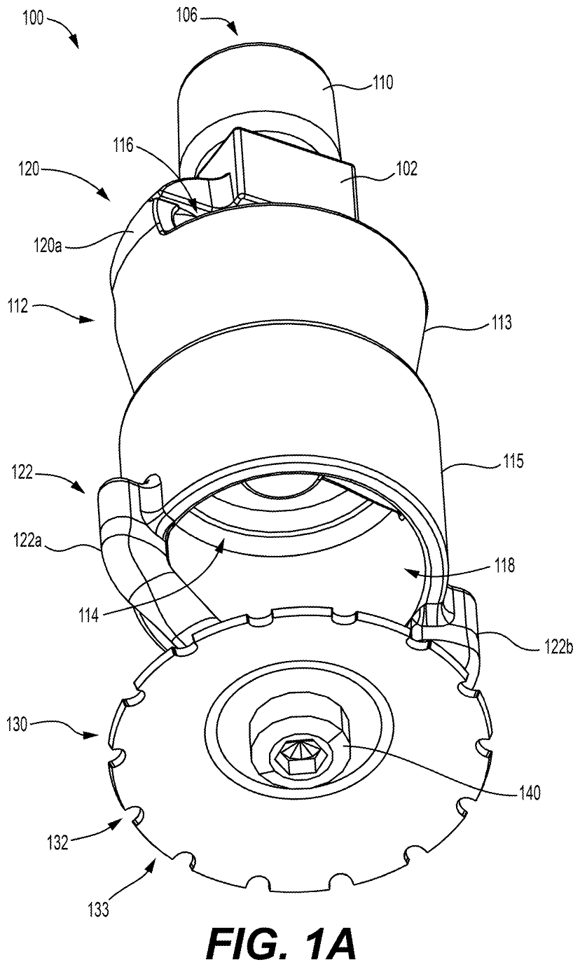

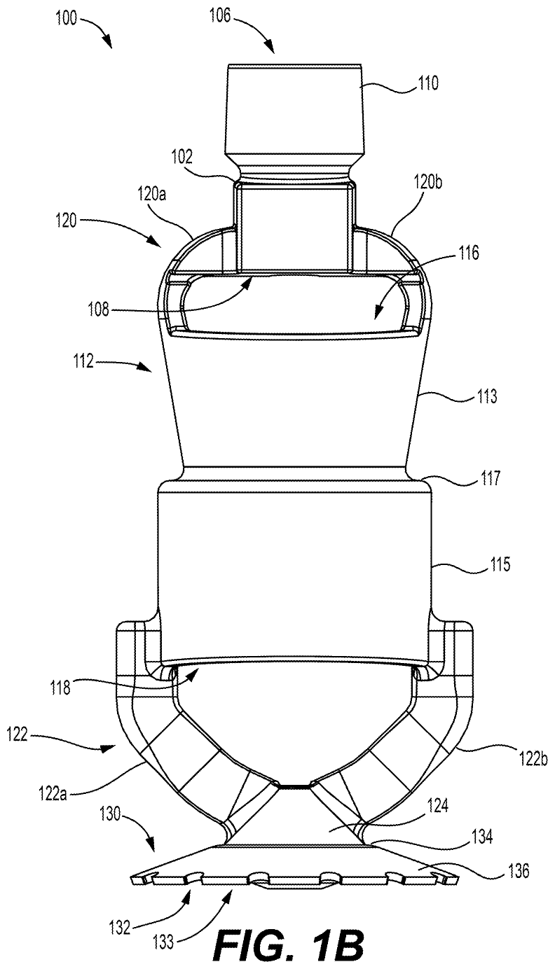

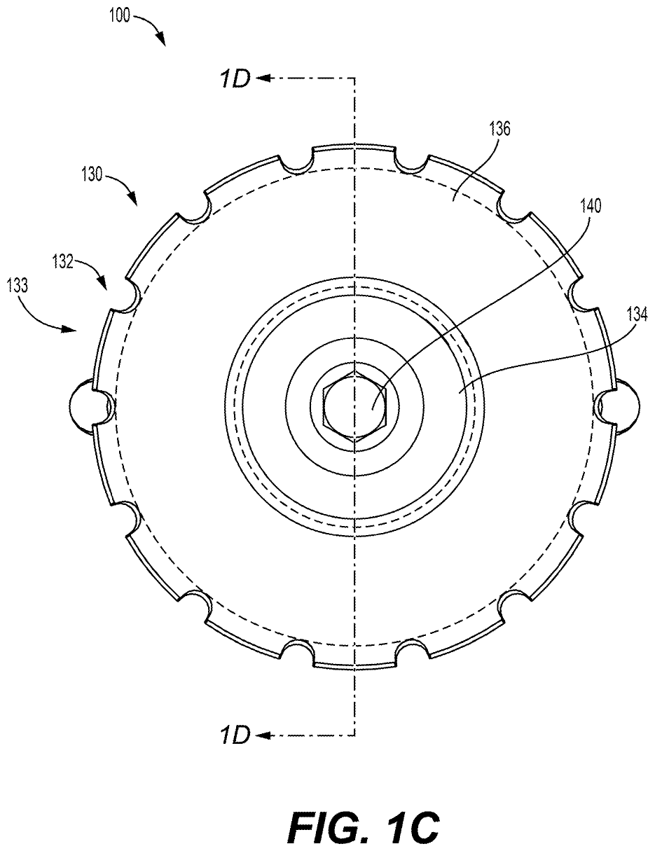

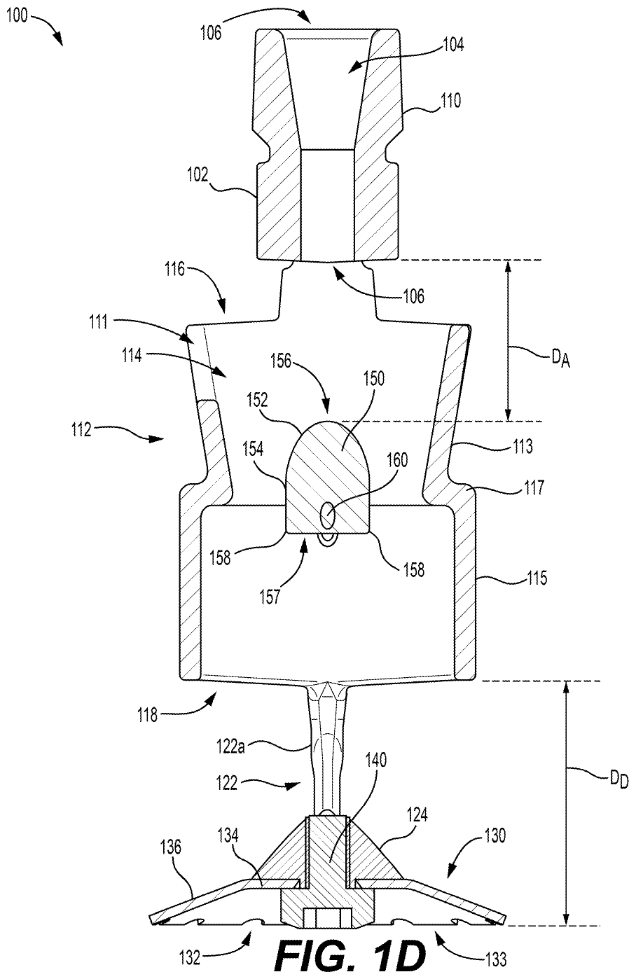

Referring now to the drawings, FIG. 1A is a schematic view of an exemplary foam-water fire sprinkler 100, according to the present disclosure. FIG. 1B is a side view of the foam-water fire sprinkler 100, according to the present disclosure. FIG. 1C is a bottom plan view of the foam-water fire sprinkler 100, according to the present disclosure. FIG. 1D is a longitudinal cross-sectional view of the foam-water fire sprinkler 100, taken along section line 1D-1D in FIG. 1C, according to the present disclosure.

The foam-water fire sprinkler 100 is a pendent fire sprinkler and includes a nozzle 102 defining a nozzle passage 104 (FIG. 1D) having a nozzle inlet 106 and a nozzle outlet 108 (FIG. 1B). A “pendent” fire sprinkler is a fire sprinkler that is mounted on a fluid conduit (e.g., a pipe of a piping network) running along a ceiling and depending downward from the conduit (the orientation shown in FIGS. 1A, 1B, and 1D). The top of the nozzle 102 has a nozzle connection portion 110 on an outer surface to allow the foam-water fire sprinkler 100 to be connected to the conduit (not shown in FIGS. 1A to 1D) for providing a pressurized fire-extinguishing fluid, such as a foam-water solution, to a nozzle input end defined by the nozzle inlet 106 of the nozzle passage 104, as detailed further below. In some embodiments, the nozzle connection portion 110 is a threaded portion that includes threads for mating with corresponding threads on the conduit. The nozzle outlet 108 is provided at an opposite end of the nozzle passage 104 relative to the nozzle inlet 106, and defines a nozzle output end. In this way, the nozzle outlet 108 is downstream of the nozzle inlet 106. The nozzle inlet 106 may have a diameter of, for example, 1 inch NPT (national pipe thread).

The foam-water fire sprinkler 100 also includes a shroud body 112. The shroud body 112 defines a shroud passage 114 having a shroud inlet 116 and a shroud outlet 118. The shroud body 112 includes a notch 111 that allows a human user to visually inspect within the should passage 114. The shroud body 112 is disposed downstream of the nozzle 102 such that the pressurized fire-extinguishing fluid and the foam solution flow from the nozzle passage 104 to the shroud passage 114, as detailed further below. The shroud inlet 116 is provided downstream of the nozzle outlet 108, and defines a shroud input end. The shroud outlet 118 is provided at an opposite end of the shroud passage 114 relative to the shroud inlet 116, and defines a shroud output end. In this way, the shroud outlet 118 is downstream of the shroud inlet 116.

The shroud body 112 includes a converging tapered shroud portion 113 and a straight shroud portion 115. The converging tapered shroud portion 113 is tapered from the shroud inlet 116 at the shroud inlet end as the shroud body 112 extends axially from the shroud inlet 116 towards the shroud outlet 118. The straight shroud portion 115 extends from the converging tapered shroud portion 113 to the shroud outlet 118 at the shroud outlet end. The straight shroud portion 115 extends generally axially from the converging tapered shroud portion 113 to the shroud outlet 118. The shroud body 112 also includes a transition shroud portion 117 that defines a radial step between the converging tapered shroud portion 113 and the straight shroud portion 115. A shroud passage diameter of the shroud passage 114 is defined by the converging tapered shroud portion 113, the straight shroud portion 115, and the transition shroud portion 117, as detailed further below with respect to FIG. 1D.

One or more nozzle arms 120 extend from a lower portion of the nozzle 102 to a top portion of the shroud body 112. The one or more nozzle arms 120 include a first nozzle arm 120a and a second nozzle arm 120b. The first nozzle arm 120a and the second nozzle arm 120b extend from opposite sides of the output end of the nozzle 102 and connect with the top portion of the shroud body 112.

One or more shroud arms 122 extend from a lower portion of the shroud body 112 and meet at a hub 124 (FIG. 1B) that is positioned downstream and is in axial alignment with the shroud outlet 118. The one or more shroud arms 122 include a first shroud arm 122a and a second shroud arm 122b. The first shroud arm 122a and the second shroud arm 122b extend from opposite sides of the output end of the shroud body 112 and meet at the hub 124.

A deflector 130 is positioned and mounted on the hub 124 so as to be impinged by foam-water fluid that passes through the shroud passage 114 upon activation of the foam-water fire sprinkler 100, as detailed further below. The deflector 130 in this particular embodiment is a non-planar, circular disk that is centered on and orthogonal to a fluid flow axis of the shroud passage 114. In some embodiments, the deflector 130 is planar. In some embodiments, the deflector 130 is non-circular. The deflector 130 may be formed, for example, of phosphor bronze and may have a desired deflector diameter and desired thickness. In alternative embodiments, the deflector diameter of the deflector 130 may vary by about ±15%. The deflector 130 has a plurality of slots 132 arrayed around a periphery of the deflector 130 and defined between a plurality of tines 133. Together, the slots 132 and the tines 133 help to generate a spray pattern of the foam-water solution as the foam-water solution impinges on the deflector 130. The deflector 130 includes a planar deflector portion 134 and an angled deflector portion 136. The planar deflector portion 134 is generally planar or flat and is coupled to the hub 124 for mounting the deflector 130 on the hub 124. For example, the deflector 130 is coupled to the hub 124 by a fastener 140, such as, for example, a bolt, a screw, or the like. The angled deflector portion 136 is angled from the planar deflector portion 134 such that the deflector 130 is non-planar. In particular, the angled deflector portion 136 extends at a non-zero angle from the planar deflector portion 134 away from the shroud outlet 118. For example, the angled deflector portion 136 extends from the planar deflector portion 134 at an angle in a range of 15° to 25° with respect to the planar deflector portion 134.

With reference to FIG. 1D, the shroud passage diameter of the shroud passage 114 decreases from the shroud inlet 116 along the converging tapered shroud portion 113 to the straight shroud portion 115. The shroud passage diameter of the shroud passage 114 increases at the transition shroud portion 117 between the converging tapered shroud portion 113 and the straight shroud portion 115. The shroud passage diameter of the shroud passage 114 remains generally constant along the straight shroud portion 115 from the transition shroud portion 117 to the shroud outlet 118. In this way, the shroud passage diameter is smallest at an end of the converging tapered shroud portion 113 that is opposite the shroud inlet 116. The deflector diameter of the deflector 130 is greater than the shroud passage diameter at the straight shroud portion 115. In this way, substantially all of the foam-water solution is directed to impinge on the deflector 130.

The foam-water fire sprinkler 100 also includes an agitator 150 disposed within the shroud passage 114. The agitator 150 is coupled to an inner surface of the shroud body 112 by one or more agitator rods 160. In particular, the agitator rods 160 extend from the agitator 150 to the inner surface of the shroud body 112. The agitator rods 160 include an elliptical cross-sectional shape. The elliptical cross-sectional shape provide strength in the direction of the loading (vertical direction in the orientation shown in FIG. 1D) and provides additional material as compared to agitator rods that have a circular cross-sectional shape or other symmetrical cross-sectional shape. The additional material provided by the elliptical cross-sectional shape provides a large safety factor to accommodate any rough use or potential corrosion through the life of the foam-water fire sprinkler 100. The agitator rods 160 have a diameter in a range of 0.075 inches (1.9 millimeters) to 0.55 inches (14 millimeters).

The agitator 150 includes a rounded agitator portion 152 and a straight agitator portion 154 that extends from the rounded agitator portion 152. The agitator 150 includes a tip 156 that faces the shroud inlet 116. The rounded agitator portion 152 is rounded at the tip 156 of the agitator 150 and extends axially away from the shroud inlet 116 to the straight agitator portion 154. In this way, a width of the agitator 150 increases from the tip 156 along the rounded agitator portion 152 to the straight agitator portion 154. The straight agitator portion 154 extends from the rounded agitator portion 152 towards the shroud outlet 118, and is substantially cylindrical. The width of the agitator 150 remains generally constant along the straight agitator portion 154 to an axial end 157 of the agitator 150 that is opposite the tip 156. In this way, the agitator 150 is considered to be bullet shaped. The straight agitator portion 154 extends generally axially such that the straight agitator portion 154 is not rounded and includes sharp edges 158 at the axial end 157 of the agitator 150. Thus, the agitator 150 extends axially from the tip 156 to the axial end 157. The axial end 157 is generally flat or generally planar to define the sharp edges 158.

The agitator 150 is positioned within the shroud passage 114 at an agitator axial distance D_{A}. The agitator axial distance D_{A} is defined in the axial direction of the foam-water fire sprinkler 100 from the nozzle outlet 108 to the tip 156 of the agitator 150. The agitator axial distance D_{A} is in a range of 0.625 inches to 1.2 inches (15 millimeters to 30 millimeters). The agitator axial distance D_{A} is selected to help agitate the foam-water solution to produce foam as the foam-water solution impingers on the agitator 150. If the tip 156 of the agitator 150 is too close to the nozzle outlet 108 (e.g., the agitator axial distance D_{A} is less than 0.625 inches (15 millimeters)), portions of the spray pattern as the foam-water solution impinges on the agitator 150 are too chaotic and result in some of the foam-water solution splashing out of the shroud inlet 116 rather than flowing towards the deflector 130. In this way, the agitator 150 being too close to the nozzle outlet 108 disallows the entire column of foam-water solution to leave the shroud body 114 intact. If the tip 156 of the agitator 150 is too far from the nozzle outlet 108 (e.g., the agitator axial distance D_{A} is greater than 1.2 inches (30 millimeters)), the foam-water solution will not be properly aerated when the foam-water solution impinges on the agitator 150 such that there may not be enough foam produced. In this way, the agitator 150 being too far from the nozzle outlet 108 causes the foam-water solution to lose velocity and to potentially impact the distribution of the foam-water solution from the foam-water fire sprinkler 100. Accordingly, the tip 156 of the agitator 150 is placed within the shroud passage 114 such that the agitator axial distance D_{A} is within the range of 0.625 inches to 1.2 inches (15 millimeters to 30 millimeters). This provides a change in direction of the water jet from the nozzle outlet 108 being less abrupt and less chaotic (as compared to if the tip 156 is placed too close to the nozzle outlet 108). Such a configuration results in no losses of foam-water solution out of the shroud inlet 116, and leading to a more efficient foam-water fire sprinkler 100 (e.g., more efficient in generating foam from the foam-water solution without losses of the foam-water solution through the shroud inlet 116) as compared to foam-water fire sprinklers without the benefit of the present disclosure.

The agitator 150 is positioned within the shroud passage 114 such that the straight agitator portion 154 (e.g., the widest portion) is axially aligned with the smallest shroud passage diameter of the shroud passage 114. In particular, the agitator 150 is positioned within the shroud passage 114 such that the rounded agitator portion 152 is entirely axially upstream of the transition shroud portion 117, and the straight agitator portion 154 is axially aligned with the transition shroud portion 117 and extends axially downstream of the transition shroud portion 117. In this way, the rounded agitator portion 152 is positioned entirely within the converging tapered shroud portion 113. The straight agitator portion 154 is positioned in the converging tapered shroud portion 113, extends through the transition shroud portion 117, and into the straight shroud portion 115. Such a configuration provides for a smallest possible annular space between the agitator 150 and the inner surface of the shroud passage 114. This provides for increasing the velocity of the foam-water solution through the shroud passage 114 as compared to if the straight agitator portion 154 was positioned entirely upstream or entirely downstream of the transition shroud portion 117. The increased velocity of the foam-water solution allows for more mechanical energy resulting in more foam production and optimized spray patterns as compared to foam-water fire sprinklers without the benefit of the present disclosure. If the straight agitator portion 154 is positioned entirely upstream or entirely downstream of the transition shroud portion 117, the velocity of the foam-water solution may not be great enough to provide the desired coverage area of the foam-water spray from the foam-water fire sprinkler 100.

The deflector 130 is positioned at a deflector axial distance D_{D} from the shroud outlet 118. The deflector axial distance D_{D} is defined in the axial direction of the foam-water fire sprinkler 100 from the shroud outlet 118 to an axial end of the deflector 130 that is furthest from the shroud outlet 118. The deflector axial distance D_{D} is in a range of 1.1 inches to 2.0 inches (28 millimeters to 51 millimeters). The deflector axial distance D_{D} is selected to help ensure substantially all of the foam-water solution impinges on the deflector 130. If the deflector 130 is too close to the shroud outlet 118 (e.g., the deflector axial distance D_{D} is less than 1.1 inches (28 millimeters)), the spray pattern of the foam-water solution will not provide the desired coverage area for the foam-water fire sprinkler 100. If the deflector 130 is too far from the shroud outlet 118 (e.g., the deflector axial distance D_{D} is greater than 2.0 inches (51 millimeters)), a substantial amount of the foam-water solution will flow around the deflector 130 from the shroud outlet 118 and not contact the deflector 130. This will cause the spray pattern of the foam-water solution to not provide the desired coverage area for the foam-water fire sprinkler 100. Thus, the deflector 130 is positioned at the deflector axial distance D_{D} within the range of 1.1 inches to 2.0 inches (28 millimeters to 51 millimeters) to ensure substantially all of the foam-water solution impinges on the deflector 130, thereby providing the desired spray pattern at the desired coverage area for the foam-water fire sprinkler 100.

In operation, the foam-water fire sprinkler 100 is activated in the event of a fire condition sensed by the sprinkler system. A foam-water solution is delivered from a piping network and output by the foam-water fire sprinkler 100 to a coverage area. The nozzle inlet 106 directs the foam-water solution into the nozzle passage 104. The nozzle passage 104 directs the foam-water solution therethrough towards the nozzle outlet 108. The nozzle outlet 108 directs the foam-water solution towards the shroud inlet 116. The shroud inlet 116 directs the foam-water solution into the shroud passage 114. In the shroud passage 114, the converging tapered shroud portion 113 guides the foam-water solution towards the agitator 150. The foam-water solution impinges on the agitator 150, thereby creating a chaotic flow and entraining air into the foam-water solution to aspirate the foam-water solution and to generate foam.

The foam-water solution fans out from the agitator 150 and the inner surface of the shroud passage 114 directs the foam-water solution towards the shroud outlet 118 and the deflector 130. The deflector 130 deflects the foam-water solution to generate a spray pattern at the coverage area. The design of the shroud body 112 ensures that all the foam-water solution and the foam is directed at the deflector 130. With the chaotic flow around the agitator 150 and against the inner surface of the shroud body 112, the shroud body 112 is used to ensure no foam-water solution or foam misses the deflector 130, resulting in an optimal usage of the foam-water solution.

The sharp edges 158 of the agitator 150 allow for the foam-water solution to separate more cleanly than smooth-curved surfaces or a sphere. If the agitator 150 were to have a smooth transition, the foam-water solution would want to grab to the surface of the agitator 150 and cause a re-accumulation of the foam-water solution and the foam downstream of the agitator 150. This re-accumulation is not desirable at this point of the discharge process as some foam has been generated at this point of the discharge process. By keeping the core of the foam-water solution and the foam clear, this allows for a more gentle distribution of the foam-water solution and the foam to the coverage area. Foam is substantially air bubbles within the foam-water solution. The agitator 150 agitates the foam-water solution to create these air bubbles (e.g., the foam). Once the foam is created, the more gentle the dispersion of the foam, generally, the better the expansion ratio to achieve the desired coverage area. If the change is abrupt, such as if the agitator has smooth-curved surfaces or is a sphere, the flow column of the foam-water solution may “pop” much of the foam that had previously been created. Accordingly, the agitator 150 of the present disclosure provides for improved foam creation, while ensuring the desired coverage area is achieved, as compared to fire sprinklers without the benefit of the present disclosure.

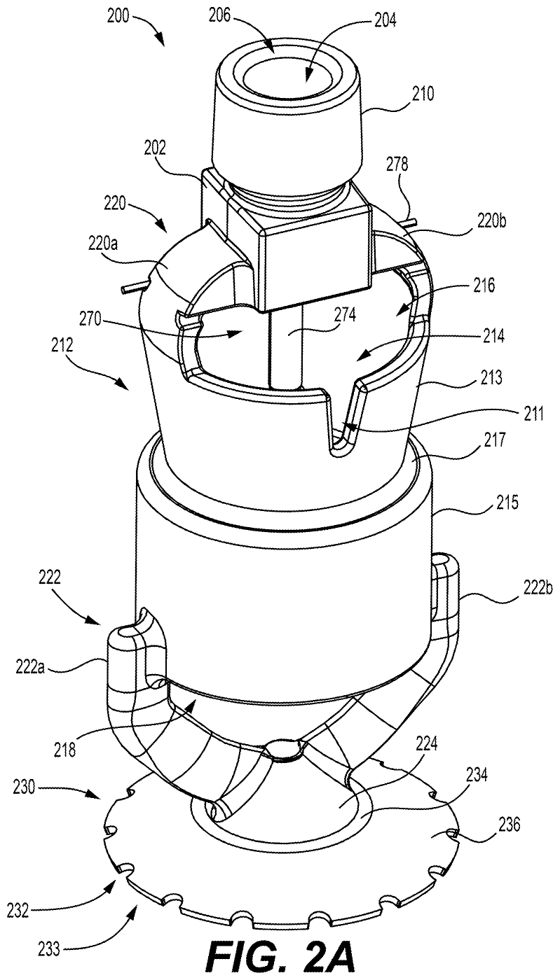

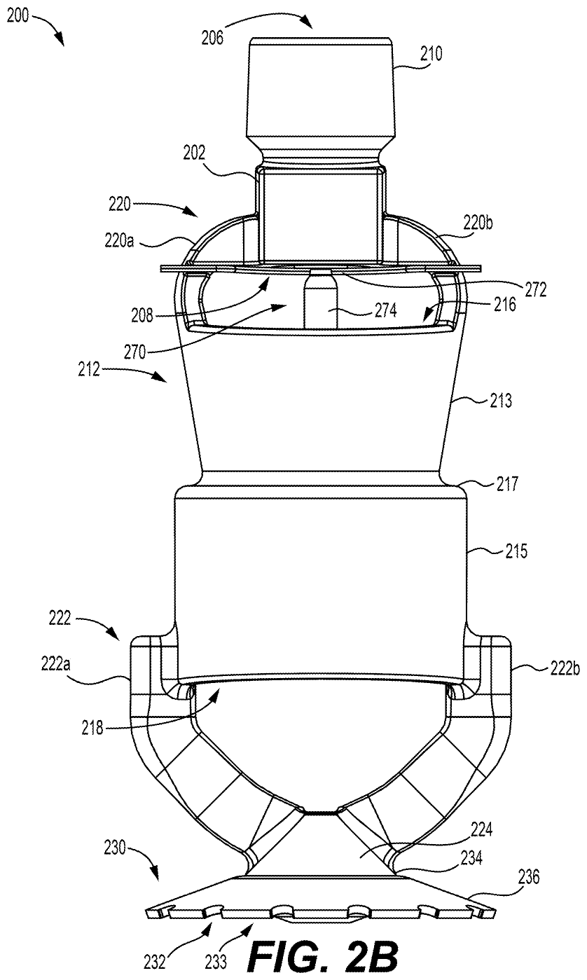

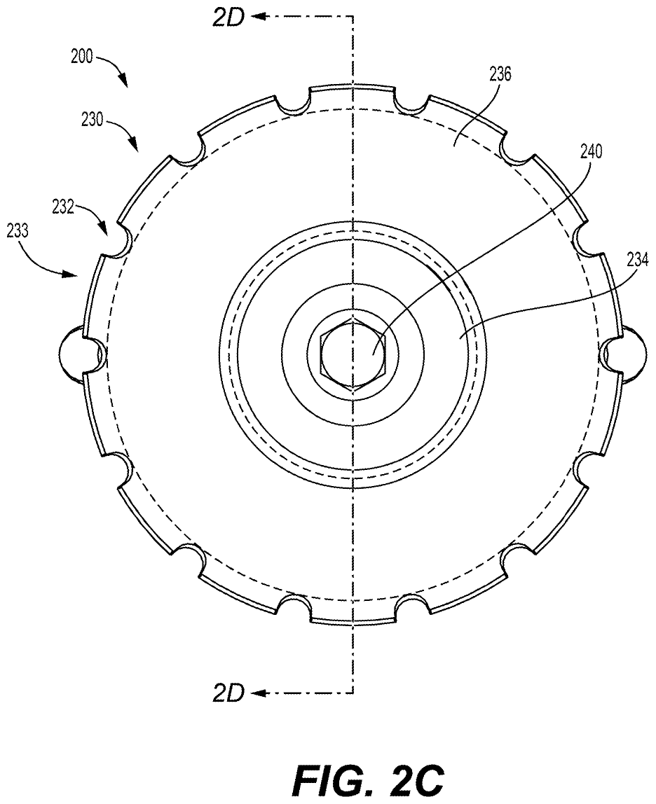

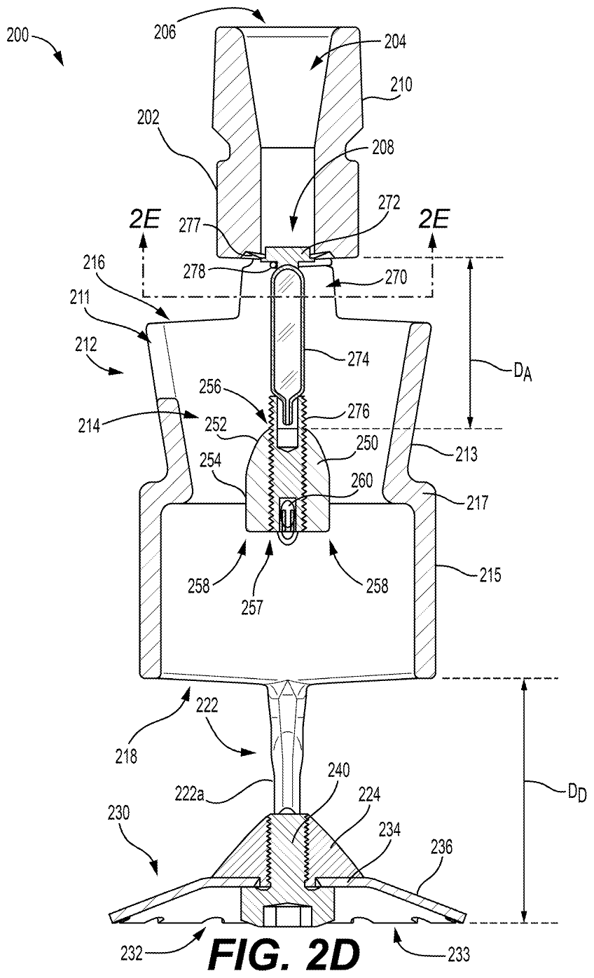

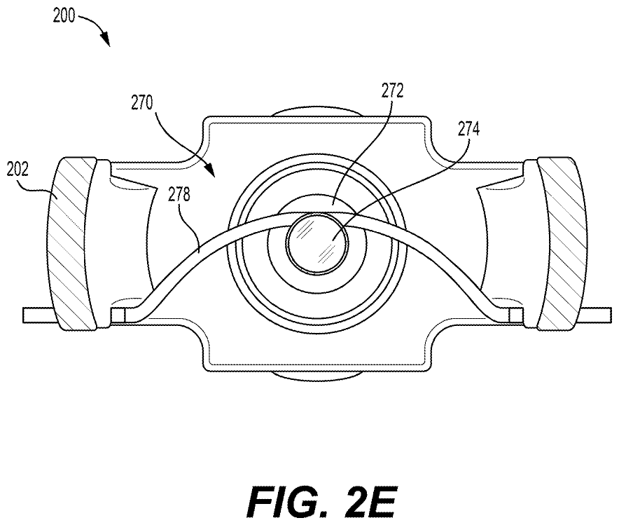

FIG. 2A is a schematic view of a foam-water fire sprinkler 200, according to another embodiment. FIG. 2B is a side view of the foam-water fire sprinkler 200 according to the present disclosure. FIG. 2C is a bottom plan view of the foam-water fire sprinkler 200, according to the present disclosure. FIG. 2D is a longitudinal cross-sectional view of the foam-water fire sprinkler 200, taken along section line 2D-2D in FIG. 2C, according to the present disclosure. FIG. 2E is a lateral cross-sectional view of the foam-water fire sprinkler 200, taken along section line 2E-2E in FIG. 2D, according to the present disclosure. The foam-water fire sprinkler 200 is substantially similar to the foam-water fire sprinkler 100 of FIGS. 1A to 1D. Similar reference numerals will be used for components of the foam-water fire sprinkler 200 that are the same as or similar to the components of the foam-water fire sprinkler 100, discussed above. The description of these components above also applies to this embodiment, and a detailed description of these components is omitted here. The foam-water fire sprinkler 200 is different than the foam-water fire sprinkler 100 in that the foam-water fire sprinkler 200 is an automatic foam-water fire sprinkler 200, as detailed further below.

The foam-water fire sprinkler 200 is a pendent fire sprinkler and includes a nozzle 202 defining a nozzle passage 204 (FIG. 2D) having a nozzle inlet 206 and a nozzle outlet 208 (FIG. 2B). The foam-water fire sprinkler 200 also includes a nozzle connection portion 210 and a shroud body 212. The shroud body 212 defines a shroud passage 214 having a shroud inlet 216 and a shroud outlet 218. The shroud body 212 includes a notch 211 that allows a human operator to visually inspect within the shroud passage 214. The shroud body 212 includes a converging tapered shroud portion 213 and a straight shroud portion 215. The shroud body 212 also includes a transition shroud portion 217 that defines a radial step between the converging tapered shroud portion 213 and the straight shroud portion 215. The foam-water fire sprinkler 200 further includes one or more nozzle arms 220 including a first nozzle arm 220a and a second nozzle arm 220b, one or more shroud arms 222 including a first shroud 222a and a second shroud arm 222b, a hub 224, a deflector 230 coupled to the hub 224 by a fastener 240, and an agitator 250 disposed within the shroud passage 214. The deflector 230 includes a plurality of slots 232 defined between a plurality of tines 233, a planar deflector portion 234, and an angled deflector portion 236. The deflector 230 is positioned at the deflector axial distance D_{D} from the shroud outlet 218, as detailed above with respect to FIG. 1D. The agitator 250 is coupled to an inner surface of the shroud body 212 by one or more agitator rods 260, and includes a rounded agitator portion 252, a straight agitator portion 254, a tip 256, an axial end 257, and sharp edges 258. The agitator 150 is positioned within the shroud passage 214 at the agitator axial distance D_{A}, as detailed above with respect to FIG. 1D.

As mentioned above, the foam-water fire sprinkler 200 is an automatic foam-water fire sprinkler 200. With reference to FIG. 2D, the foam-water fire sprinkler 200 includes a release mechanism 270 having a seal cap 272 and a thermally-responsive element 274, e.g., a frangible bulb. The seal cap 272 is disposed within the nozzle outlet 208 to seal the nozzle outlet 208. Before the foam-water fire sprinkler 200 is triggered, the foam-water solution sits within the nozzle passage 204 and the seal cap 272 prevents the foam-water solution from flowing out of the nozzle passage 204 and towards the deflector 230. The thermally-responsive element 274 (e.g., the frangible bulb) is positioned between the agitator 250 and the seal cap 272 to hold the seal cap 272 in place within the nozzle outlet 208. As shown in FIG. 2D, the thermally-responsive element 274 (e.g., the frangible bulb) is positioned between the seal cap 272 and a set screw 276. The set screw 276 is coupled to the agitator 250, for example, by a threaded connection. The release mechanism 270 also includes a disc spring 277 (e.g., a Belleville spring washer) that pushes on the seal cap 272 from the nozzle 202 creating a water tight seal between the nozzle 202 and the seal cap 272.

The thermally-responsive element 274 is designed to burst at a predetermined temperature, which, in turn, releases the seal cap 272 from the nozzle outlet 208 and allows the foam-water solution to be output from the nozzle passage 204. A spring pin 278 extends across the seal cap 272 to eject the seal cap 272 away from the nozzle 202 upon release of the seal cap 272 from the nozzle outlet 208. Of course, other types of release mechanisms may be used, including, but not limited to, for example, a fusible link assembly or a sensor, a strut, and a lever assembly. Components of the release mechanism 270 can be inserted within the shroud passage 214 through the notch 211. For example, a human operator can insert the thermally-responsive element 274 through the notch 211.

The foam-water fire sprinkler 200 operates substantially as does the foam-water fire sprinkler 100 of FIGS. 1A to 1D. However, rather than the foam-water solution flowing freely from the piping network when a fire condition is sensed by the system, the foam-water fire sprinkler 200 is activated in the event of a fire condition sensed by the foam-water fire sprinkler 200. In particular, the thermally-responsive element 274 (e.g., the frangible bulb) bursts or otherwise actuates in response to the predetermined temperature being sensed by the thermally-responsive element 274 (e.g., heat from a fire). This releases the seal cap 272 and allows the foam-water solution to be delivered from the piping network and output by the foam-water fire sprinkler 200 to a coverage area. Thus, the foam-water fire sprinkler 200 is automatic and only foam-water fire sprinklers 200 in the system that sense the fire condition by the thermally-responsive element 274 are activated, rather than the foam-water solution flowing through all of the foam-water fire sprinklers 100 of the system when the system is activated. The foam-water fire sprinkler 200 directs the foam-water solution therethrough to create the foam as detailed above with respect to the foam-water fire sprinkler 100 of FIGS. 1A to 1D.

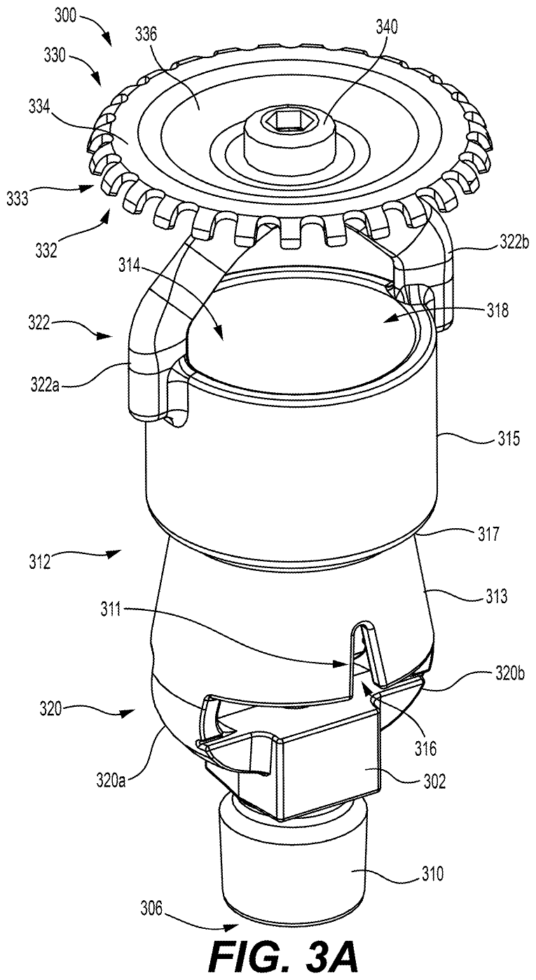

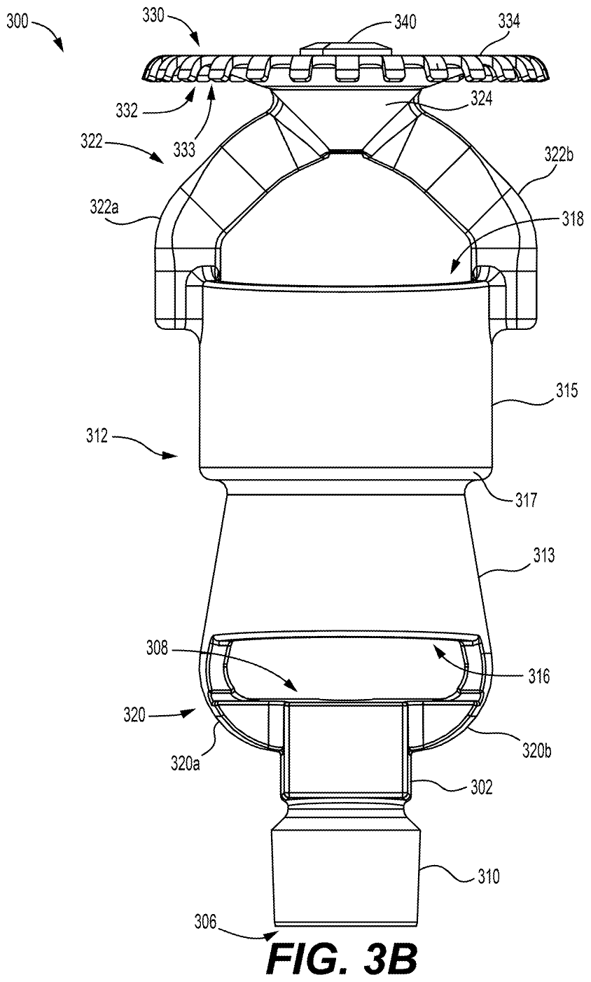

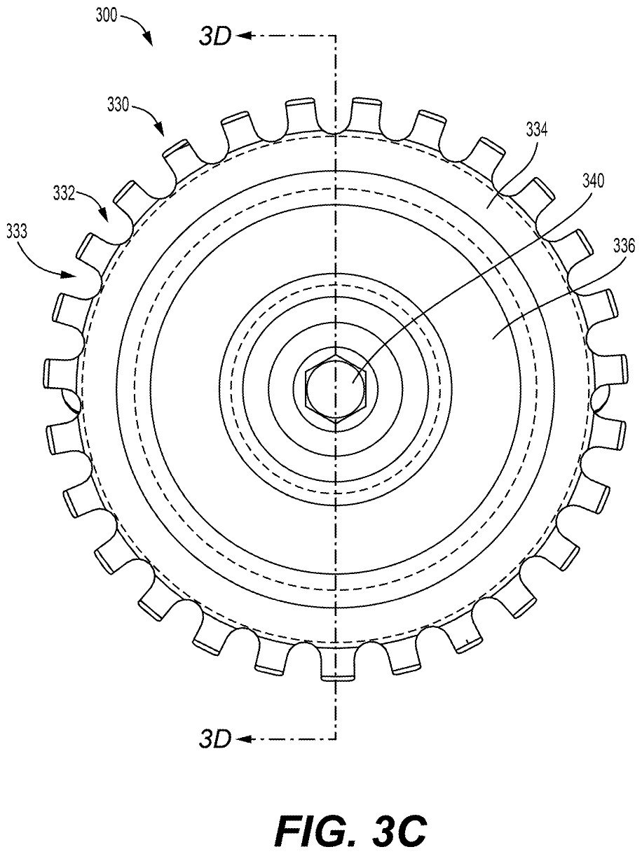

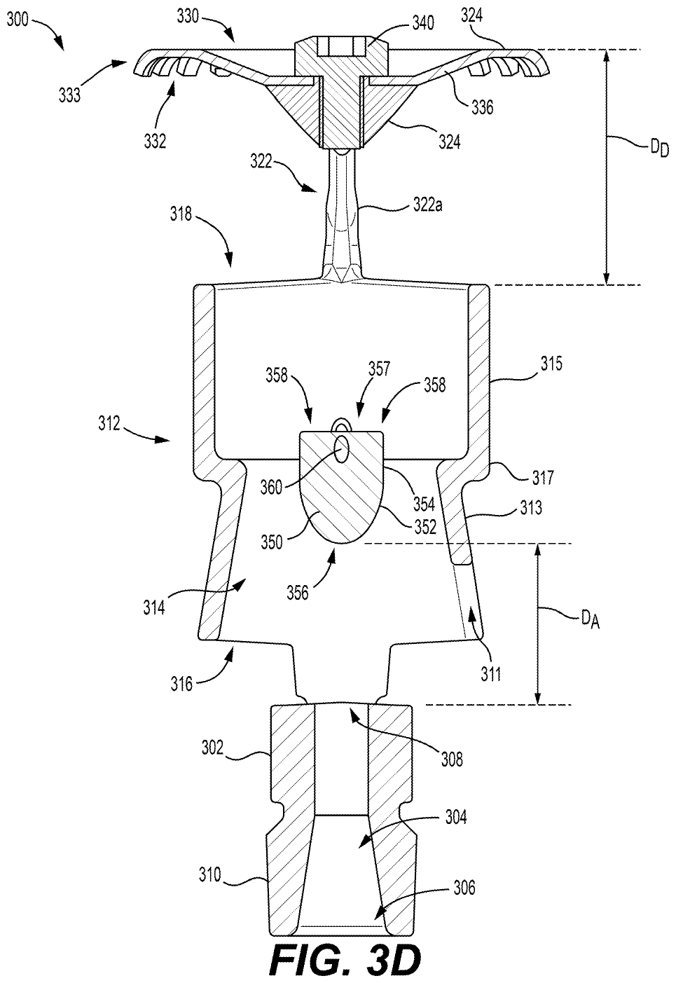

FIG. 3A is a schematic view of a foam-water fire sprinkler 300, according to another embodiment. FIG. 3B is a side view of the foam-water fire sprinkler 300 of FIG. 3A, according to the present disclosure. FIG. 3C is a bottom plan view of the foam-water fire sprinkler 300 of FIG. 3A, according to the present disclosure. FIG. 3D is a longitudinal cross-sectional view of the foam-water fire sprinkler 300, taken along section line 3D-3D in FIG. 3C, according to the present disclosure. The foam-water fire sprinkler 300 is substantially similar to the foam-water fire sprinkler 100 of FIGS. 1A to 1D. Similar reference numerals will be used for components of the foam-water fire sprinkler 300 that are the same as or similar to the components of the foam-water fire sprinkler 100, discussed above. The description of these components above also applies to this embodiment, and a detailed description of these components is omitted here. The foam-water fire sprinkler 300 is different than the foam-water fire sprinkler 100 in that the foam-water fire sprinkler 300 is an upright fire sprinkler. An “upright” fire sprinkler is a fire sprinkler that is mounted on a fluid conduit (e.g., a pipe of a piping network) running along a ceiling and depending upward from the conduit (the orientation shown in FIGS. 3A, 3B, and 3D).

The foam-water fire sprinkler 300 includes a nozzle 302 defining a nozzle passage 304 (FIG. 3D) having a nozzle inlet 306 and a nozzle outlet 308 (FIG. 3B). The foam-water fire sprinkler 300 also includes a nozzle connection portion 310 and a shroud body 312. The shroud body 312 defines a shroud passage 314 having a shroud inlet 316 and a shroud outlet 318. The shroud body 312 includes a notch 311 that allows a human operator to visually inspect within the shroud passage 314. The shroud body 312 includes a converging tapered shroud portion 313 and a straight shroud portion 315. The shroud body 312 also includes a transition shroud portion 317 that defines a radial step between the converging tapered shroud portion 313 and the straight shroud portion 315. The foam-water fire sprinkler 300 further includes one or more nozzle arms 320 including a first nozzle arm 320a and a second nozzle arm 320b, one or more shroud arms 322 including a first shroud 322a and a second shroud arm 322b, a hub 324, a deflector 330 coupled to the hub 324 by a fastener 340, and an agitator 350 disposed within the shroud passage 314. The deflector 330 includes a plurality of slots 332 defined between a plurality of tines 333, a planar deflector portion 334, and an angled deflector portion 336. The deflector 330 is positioned at the deflector axial distance D_{D} from the shroud outlet 318, as detailed above with respect to FIG. 1D. The agitator 350 is coupled to an inner surface of the shroud body 312 by one or more agitator rods 360, and includes a rounded agitator portion 352, a straight agitator portion 354, a tip 356, an axial end 357, and sharp edges 358. The agitator 350 is positioned within the shroud passage 314 at the agitator axial distance D_{A}, as detailed above with respect to FIG. 1D.

The deflector 330 is different than the deflector 130 of FIGS. 1A to 1D. In particular, the deflector 330 in this particular embodiment is a substantially non-planar, circular disk that is centered on and orthogonal to the fluid flow axis of the shroud passage 314. In some embodiments, the deflector 330 is planar. In some embodiments, the deflector 330 is non-circular. The angled deflector portion 336 is coupled to the hub 324 for mounting the deflector 330 on the hub 324. The angled deflector portion 336 is angled from the hub 324 such that the deflector 330 is non-planar. In particular, the angled deflector portion 336 extends at a non-zero angle from the hub 324 away from the shroud outlet 318. For example, the angled deflector portion 336 extends from the hub 324 at an angle in a range of 15° to 25° with respect to the hub 324. The planar deflector portion 334 extends radially outward from the angled deflector portion 336 and is perpendicular (or orthogonal) to the fluid flow axis. The plurality of tines 333 extends from the planar deflector portion 334 and the plurality of slots 332 is defined between the plurality of tines 333. The plurality of tines 333 extend from the planar deflector portion 334 at a non-zero angle toward the shroud outlet 318. In this way, the plurality of tines 333 redirect the foam-water solution towards the ground to generate the spray pattern at the coverage area. The foam-water fire sprinkler 300 operates substantially similar as does the foam-water fire sprinkler 100 of FIGS. 1A to 1D.

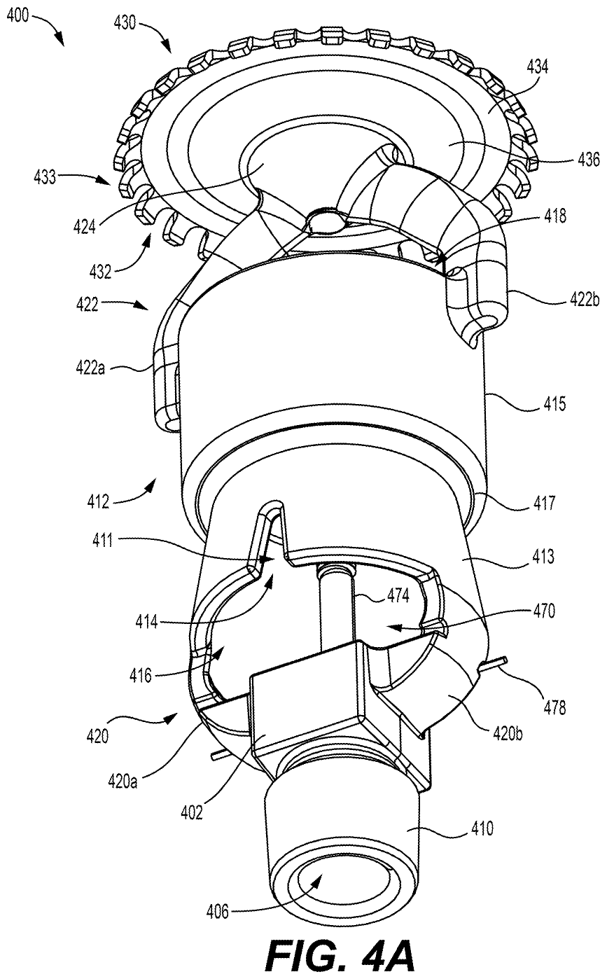

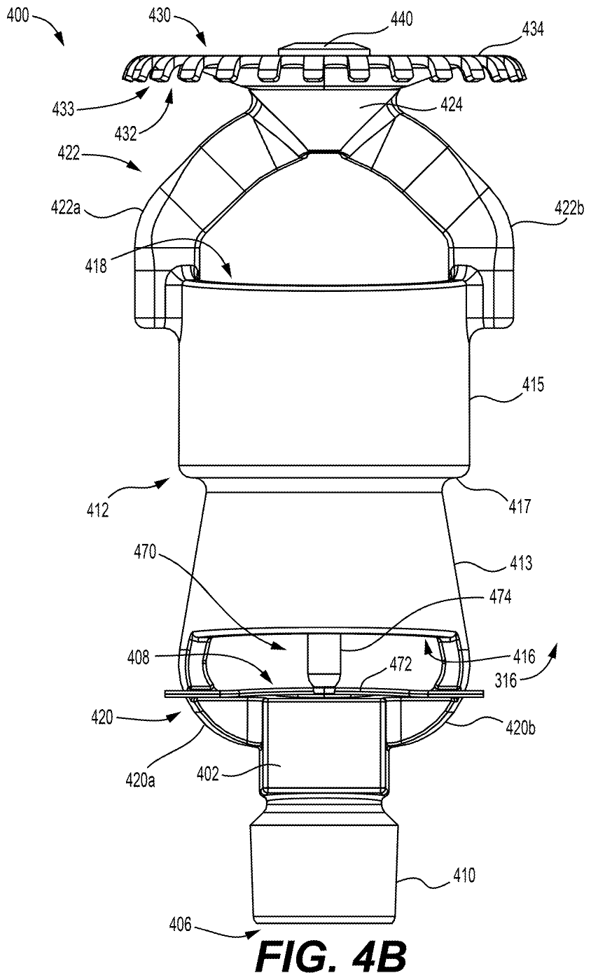

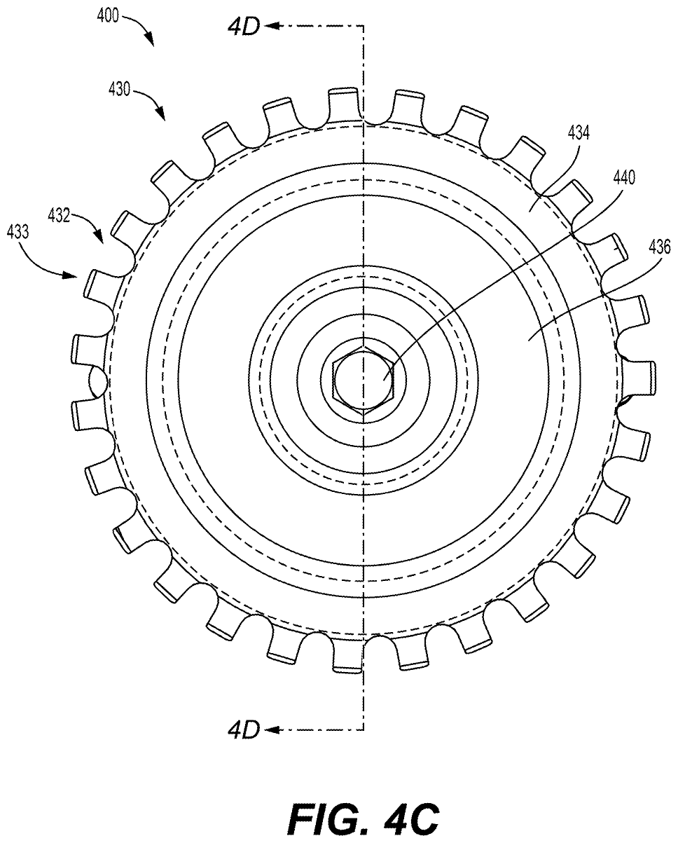

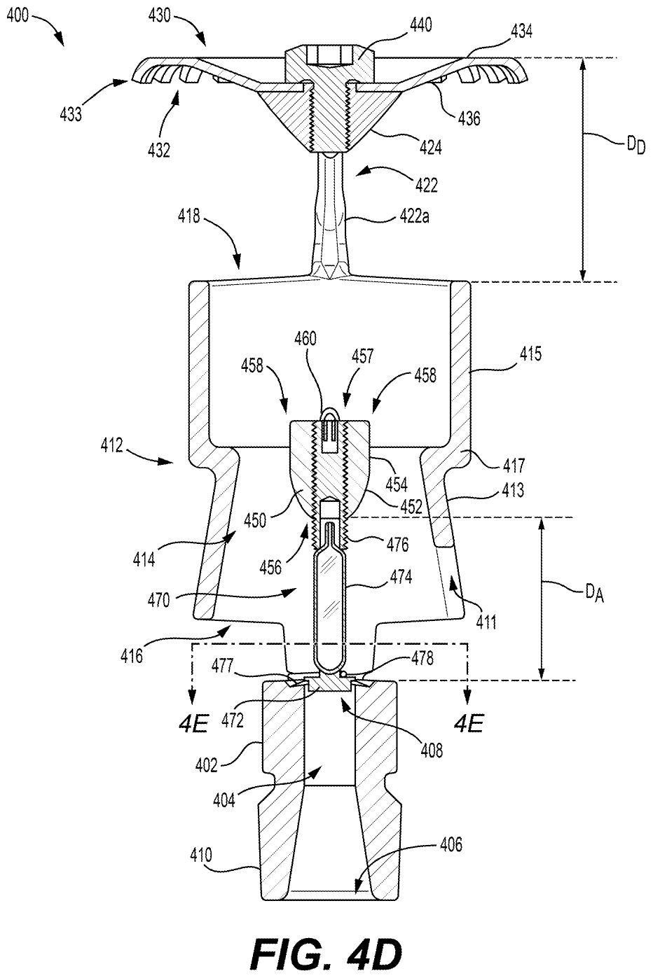

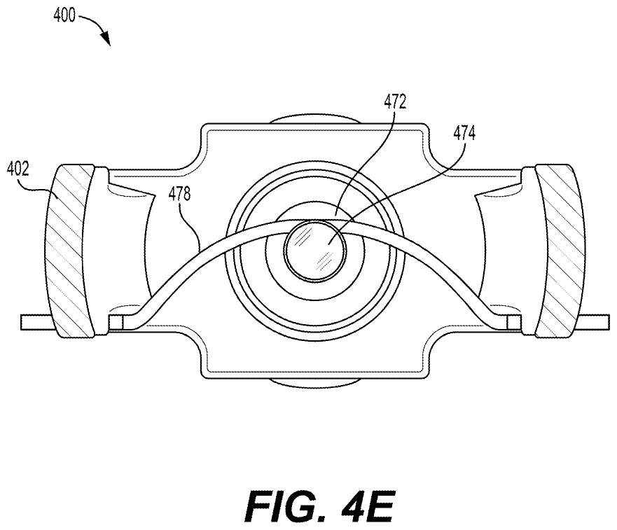

FIG. 4A is a schematic view of a foam-water fire sprinkler 400, according to another embodiment. FIG. 4B is a side view of the foam-water fire sprinkler 400, according to the present disclosure. FIG. 4C is a bottom plan view of the foam-water fire sprinkler 400, according to the present disclosure. FIG. 4D is a longitudinal cross-sectional view of the foam-water fire sprinkler 400, taken along section line 4D-4D in FIG. 4C, according to the present disclosure. FIG. 4E is a lateral cross-sectional view of the foam-water fire sprinkler 400, taken along section line 4E-4E in FIG. 4D, according to the present disclosure. The foam-water fire sprinkler 400 is substantially similar to the foam-water fire sprinkler 300 of FIGS. 3A to 3D. Similar reference numerals will be used for components of the foam-water fire sprinkler 400 that are the same as or similar to the components of the foam-water fire sprinkler 300, discussed above. The description of these components above also applies to this embodiment, and a detailed description of these components is omitted here. The foam-water fire sprinkler 400 is different than the foam-water fire sprinkler 300 in that the foam-water fire sprinkler 400 is an automatic foam-water fire sprinkler 400.

The foam-water fire sprinkler 400 is an upright fire sprinkler and includes a nozzle 402 defining a nozzle passage 404 (FIG. 4D) having a nozzle inlet 406 and a nozzle outlet 408 (FIG. 4B). The foam-water fire sprinkler 400 also includes a nozzle connection portion 410 and a shroud body 412. The shroud body 412 defines a shroud passage 414 having a shroud inlet 416 and a shroud outlet 418. The shroud body 412 includes a notch 411 that allows a human operator to visually inspect within the shroud passage 414. The shroud body 412 includes a converging tapered shroud portion 413 and a straight shroud portion 415. The shroud body 412 also includes a transition shroud portion 417 that defines a radial step between the converging tapered shroud portion 413 and the straight shroud portion 415. The foam-water fire sprinkler 400 further includes one or more nozzle arms 420 including a first nozzle arm 420a and a second nozzle arm 420b, one or more shroud arms 422 including a first shroud 422a and a second shroud arm 422b, a hub 424, a deflector 430 coupled to the hub 424 by a fastener 440, and an agitator 450 disposed within the shroud passage 414. The deflector 430 includes a plurality of slots 432 defined between a plurality of tines 433, a planar deflector portion 434, and an angled deflector portion 436. The deflector 430 is positioned at the deflector axial distance D_{D} from the shroud outlet 418, as detailed above with respect to FIG. 1D. The agitator 450 is coupled to an inner surface of the shroud body 412 by one or more agitator rods 460, and includes a rounded agitator portion 452, a straight agitator portion 454, a tip 456, an axial end 457, and sharp edges 458. The agitator 450 is positioned within the shroud passage 414 at the agitator axial distance D_{A}, as detailed above with respect to FIG. 1D.

As mentioned above, the foam-water fire sprinkler 400 is an automatic foam-water fire sprinkler 400. With reference to FIG. 4D, the foam-water fire sprinkler 400 includes a release mechanism 470. The release mechanism 470 is substantially similar to the release mechanism 270 of FIGS. 2A to 2E. The release mechanism 470 includes a seal cap 472, a thermally-responsive element 474, e.g., a frangible bulb, a set screw 476, a disc spring 477, and a spring pin 478. The seal cap 472 is disposed within the nozzle outlet 408 to seal the nozzle outlet 408. The thermally-responsive element 474 (e.g., the frangible bulb) is positioned between the agitator 450 and the seal cap 472 to hold the seal cap 472 in place within the nozzle outlet 408. As shown in FIG. 4D, the thermally-responsive element 474 (e.g., the frangible bulb) is positioned between the seal cap 472 and the set screw 476. Other types of release mechanisms may be used, including, but not limited to, for example, a fusible link assembly or a sensor, a strut, and a lever assembly. Components of the release mechanism 470 can be inserted within the shroud passage 414 through the notch 411. For example, a human operator can insert the thermally-responsive element 474 through the notch 411.

The foam-water fire sprinkler 400 operates substantially as does the foam-water fire sprinkler 100 and 300 of FIGS. 1A to 1D and 3A to 3D, respectively. However, the foam-water fire sprinkler 400 is activated in the event of a fire condition sensed by the foam-water fire sprinkler 400. In particular, the thermally-responsive element 474 (e.g., the frangible bulb) bursts or otherwise actuates in response to the predetermined temperature being sensed by the thermally-responsive element 474 (e.g., heat from a fire). This releases the seal cap 472 and allows the foam-water solution to be delivered from the piping network and output by the foam-water fire sprinkler 400 to a coverage area. Thus, the foam-water fire sprinkler 400 is automatic and only foam-water fire sprinklers 400 in the system that sense the fire condition by the thermally-responsive element 474 are activated, rather than the foam-water solution flowing through all of the foam-water fire sprinklers 100 and 300 of the system when the system is activated. The foam-water fire sprinkler 400 directs the foam-water solution therethrough to create the foam as detailed above with respect to the foam-water fire sprinkler 100 of FIGS. 1A to 1D.

Although the foregoing description is directed to the preferred embodiments of the present disclosure, other variations and modifications will be apparent to one with skill in the art that the fire sprinklers of the present disclosure may be provided using some or all of the mentioned features and components without departing from the spirit and scope of the present disclosure. The embodiments described above are specific examples of a single broader invention that may have greater scope than any of the singular descriptions taught. There may be many alterations made in the descriptions without departing from the spirit and the scope of the present disclosure. Moreover, features described in connection with one embodiment of the present disclosure may be used in conjunction with other embodiments, even if not explicitly stated above.

1. A foam-water fire sprinkler comprising:
a nozzle defining a nozzle passage having a nozzle inlet and a nozzle outlet, the nozzle passage receiving a foam-water solution therein through the nozzle inlet;
a shroud body defining a shroud passage having a shroud inlet and a shroud outlet, the shroud passage receiving the foam-water solution from the nozzle passage through the shroud inlet;
an agitator positioned within the shroud passage, the agitator having a rounded agitator portion and a straight agitator portion that extends from the rounded agitator portion, the foam-water solution impinging on the agitator at the rounded agitator portion to aspirate the foam-water solution with air to generate foam, and a portion of the foam-water solution separating from the agitator at the straight agitator portion; and
a deflector that deflects the foam-water solution and the foam to generate a spray pattern of the foam-water solution and the foam at a coverage area.

2. The foam-water fire sprinkler of claim 1, wherein the agitator includes a tip defined by the rounded agitator portion, and the agitator is positioned within the shroud passage at an agitator axial distance defined from the nozzle outlet to the tip of the agitator, and the agitator axial distance being in a range of 0.625 inches to 1.2 inches (15 millimeters to 30 millimeters).

3. The foam-water fire sprinkler of claim 1, wherein the straight agitator portion extends from the rounded agitator portion to an axial end of the agitator, the axial end being generally planar and defining sharp edges of the agitator, the sharp edges causing the portion of foam-water solution to separate from the agitator and flow towards the deflector.

4. The foam-water fire sprinkler of claim 1, wherein the deflector is positioned at a deflector axial distance from the shroud outlet, the deflector axial distance being in a range of 1.1 inches to 2.0 inches (28 millimeters to 51 millimeters).

5. The foam-water fire sprinkler of claim 1, wherein the deflector includes a planar deflector portion and an angled deflector portion, the angled deflector portion being angled from the planar deflector portion at an angle in a range of 15 degrees to 25 degrees.

6. The foam-water fire sprinkler of claim 1, wherein the deflector includes a plurality of tines and a plurality of slots defined between the plurality of tines, the plurality of tines being angled away from the shroud outlet.

7. The foam-water fire sprinkler of claim 1, wherein the deflector includes a plurality of tines and a plurality of slots defined between the plurality of tines, the plurality of tines being angled toward the shroud outlet.

8. The foam-water fire sprinkler of claim 1, further comprising a release mechanism including a seal cap disposed within the nozzle outlet to seal the nozzle outlet, and a thermally-responsive element positioned between the agitator and the seal cap to hold the seal cap in place within the nozzle outlet, the thermally-responsive element releasing the seal cap at a predetermined temperature such that the seal cap is released from the nozzle outlet to allow the foam-water solution to flow through the nozzle passage and into the shroud passage towards the deflector.

9. The foam-water fire sprinkler of claim 8, wherein the release mechanism further includes a set screw coupled to the agitator and the thermally-responsive element.

10. The foam-water fire sprinkler of claim 8, wherein the release mechanism further includes a spring pin that extends across the seal cap to eject the seal cap away from the nozzle upon release of the seal cap.

11. The foam-water fire sprinkler of claim 1, wherein the shroud body has a converging tapered shroud portion and a straight shroud portion, the converging tapered shroud portion tapering from the shroud inlet to the straight shroud portion, and the straight shroud portion extends substantially axially from the converging tapered shroud portion to the shroud outlet.

12. The foam-water fire sprinkler of claim 11, wherein the agitator is positioned within the shroud passage such that the straight agitator portion extends from the converging tapered shroud portion to the straight shroud portion.

13. The foam-water fire sprinkler of claim 12, wherein the straight agitator portion is axially aligned with a smallest shroud passage diameter of the shroud passage defined by the converging tapered shroud portion.

14. The foam-water fire sprinkler of claim 12, wherein the rounded agitator portion is positioned entirely within the converging tapered shroud portion.

15. The foam-water fire sprinkler of claim 11, wherein the shroud body includes a transition shroud portion that defines a radial step between the converging tapered shroud portion and the straight shroud portion.

16. The foam-water fire sprinkler of claim 15, wherein a shroud passage diameter of the shroud passage is defined by the converging tapered shroud portion, the straight shroud portion, and the transition shroud portion, and the shroud passage diameter decreases from the shroud inlet along the converging tapered shroud portion to the straight shroud portion, the shroud passage diameter increases at the transition shroud portion, and the shroud passage diameter remains generally constant along the straight shroud portion from the transition shroud portion to the shroud outlet.

17. The foam-water fire sprinkler of claim 16, wherein the deflector has a deflector diameter that is greater than the shroud passage diameter at the straight shroud portion.

18. A foam-water fire sprinkler comprising:
a nozzle defining a nozzle passage having a nozzle inlet and a nozzle outlet, the nozzle passage receiving a foam-water solution therein through the nozzle inlet;
a shroud body defining a shroud passage having a shroud inlet and a shroud outlet, the shroud passage receiving the foam-water solution from the nozzle passage through the shroud inlet, and the shroud body comprising:
a converging tapered shroud portion that tapers inward from the shroud inlet such that a shroud passage diameter of the shroud passage decreases from the shroud inlet along the converging tapered shroud portion;
a straight shroud portion that extends substantially axially from the converging tapered shroud portion to the shroud outlet, wherein the shroud passage diameter remains generally constant along the straight shroud portion to the shroud outlet; and
a transition shroud portion that defines a radial step between the converging tapered shroud portion and the straight shroud portion, wherein the shroud passage diameter increases at the transition shroud portion between the converging tapered shroud portion and the straight shroud portion;
an agitator positioned within the shroud passage, the agitator comprising:
a rounded agitator portion;
a straight agitator portion that extends from the rounded agitator portion, wherein the agitator is positioned within the shroud passage such that the straight agitator portion is axially aligned with a smallest shroud passage diameter of the shroud passage defined by the converging tapered shroud portion;
a tip defined by the rounded agitator portion, wherein the agitator is positioned within the shroud passage at an agitator axial distance defined from the nozzle outlet to the tip of the agitator, and the agitator axial distance is in a range of 0.625 inches to 1.2 inches (15 millimeters to 30 millimeters); and
an axial end that is generally planar and defines sharp edges of the agitator, wherein the foam-water solution impinges on the agitator at the rounded agitator portion to aspirate the foam-water solution with air to generate foam, and the sharp edges causing a portion of the foam-water solution to separate from the agitator; and
a deflector that deflects the foam-water solution and the foam to generate a spray pattern of the foam-water solution and the foam at a coverage area, wherein the deflector is positioned at a deflector axial distance from the shroud outlet, the deflector axial distance being in a range of 1.1 inches to 2.0 inches (28 millimeters to 51 millimeters).

19. The foam-water fire sprinkler of claim 18, wherein the deflector has a deflector diameter that is greater than the shroud passage diameter at the straight shroud portion.

20. The foam-water fire sprinkler of claim 18, wherein the deflector includes a planar deflector portion and an angled deflector portion, the angled deflector portion being angled from the planar deflector portion at an angle in a range of 15 degrees to 25 degrees.

21. The foam-water fire sprinkler of claim 18, wherein the deflector includes a plurality of tines and a plurality of slots defined between the plurality of tines, the plurality of tines being angled away from the shroud outlet.

22. The foam-water fire sprinkler of claim 18, wherein the deflector includes a plurality of tines and a plurality of slots defined between the plurality of tines, the plurality of tines being angled toward the shroud outlet.

23. The foam-water fire sprinkler of claim 18, wherein the agitator is positioned within the shroud passage such that the straight agitator portion extends axially from the converging tapered shroud portion to the straight shroud portion.

24. The foam-water fire sprinkler of claim 23, wherein the rounded agitator portion is positioned entirely within the converging tapered shroud portion.

25. The foam-water fire sprinkler of claim 18, further comprising a release mechanism including a seal cap disposed within the nozzle outlet to seal the nozzle outlet, and a thermally-responsive element positioned between the agitator and the seal cap to hold the seal cap in place within the nozzle outlet, the thermally-responsive element releasing the seal cap at a predetermined temperature such that the seal cap is released from the nozzle outlet to allow the foam-water solution to flow through the nozzle passage and into the shroud passage towards the deflector.

26. The foam-water fire sprinkler of claim 25, wherein the release mechanism further includes a set screw coupled to the agitator and the thermally-responsive element.

27. The foam-water fire sprinkler of claim 25, wherein the release mechanism further includes a spring pin that extends across the seal cap to eject the seal cap away from the nozzle upon release of the seal cap.

28. A foam-water fire sprinkler comprising:
a nozzle defining a nozzle passage having a nozzle inlet and a nozzle outlet, the nozzle passage receiving a foam-water solution therein through the nozzle inlet;
a shroud body defining a shroud passage having a shroud inlet and a shroud outlet, the shroud passage receiving the foam-water solution from the nozzle passage through the shroud inlet;
an agitator positioned within the shroud passage, the foam-water solution impinging on the agitator to aspirate the foam-water solution with air to generate foam;
a deflector that deflects the foam-water solution and the foam to generate a spray pattern of the foam-water solution and the foam at a coverage area; and
a release mechanism including a seal cap disposed within the nozzle outlet to seal the nozzle outlet, and a thermally-responsive element positioned between the agitator and the seal cap to hold the seal cap in place within the nozzle outlet, the thermally-responsive element releasing the seal cap at a predetermined temperature such that the seal cap is released from the nozzle outlet to allow the foam-water solution to flow through the nozzle passage and into the shroud passage towards the deflector.

29. The foam-water fire sprinkler of claim 28, wherein the release mechanism further includes a set screw coupled to the agitator and the thermally-responsive element.

30. The foam-water fire sprinkler of claim 28, wherein the release mechanism further includes a spring pin that extends across the seal cap to eject the seal cap away from the nozzle upon release of the seal cap.

31. The foam-water fire sprinkler of claim 28, wherein the agitator is positioned within the shroud passage at an agitator axial distance defined from the nozzle outlet to the agitator, and the agitator axial distance is in a range of 0.625 inches to 1.2 inches (15 millimeters to 30 millimeters).

32. The foam-water fire sprinkler of claim 28, wherein the deflector is positioned at a deflector axial distance from the shroud outlet, the deflector axial distance being in a range of 1.1 inches to 2.0 inches (28 millimeters to 51 millimeters).

33. The foam-water fire sprinkler of claim 28, wherein the deflector includes a planar deflector portion and an angled deflector portion, the angled deflector portion being angled from the planar deflector portion at an angle in a range of 10 degrees to 30 degrees.

34. The foam-water fire sprinkler of claim 28, wherein the deflector includes a plurality of tines and a plurality of slots defined between the plurality of tines, the plurality of tines being angled away from the shroud outlet.

35. The foam-water fire sprinkler of claim 28, wherein the deflector includes a plurality of tines and a plurality of slots defined between the plurality of tines, the plurality of tines being angled toward the shroud outlet.

36. The foam-water fire sprinkler of claim 28, wherein the shroud body has a converging tapered shroud portion and a straight shroud portion, the converging tapered shroud portion tapering from the shroud inlet to the straight shroud portion, and the straight shroud portion extends substantially axially from the converging tapered shroud portion to the shroud outlet.

37. The foam-water fire sprinkler of claim 36, wherein the shroud body includes a transition shroud portion that defines a radial step between the converging tapered shroud portion and the straight shroud portion.

38. The foam-water fire sprinkler of claim 37, wherein a shroud passage diameter of the shroud passage is defined by the converging tapered shroud portion, the straight shroud portion, and the transition shroud portion, and the shroud passage diameter decreases from the shroud inlet along the converging tapered shroud portion to the straight shroud portion, the shroud passage diameter increases at the transition shroud portion, and the shroud passage diameter remains generally constant along the straight shroud portion from the transition shroud portion to the shroud outlet.

39. The foam-water fire sprinkler of claim 38, wherein the deflector has a deflector diameter that is greater than the shroud passage diameter at the straight shroud portion.
